(19) United States
(12) Patent Application Publication
(10) Pub. No.: US 2024/0296066 A1
(43) Pub. Date: Sep. 5, 2024

(54) ASYNCHRONOUS TASK FRAMEWORK

(71) Applicant: Snap Inc., Santa Monica, CA (US)

(72) Inventor: Ryan Olson, Seattle, WA (US)

(21) Appl. No.: 18/593,605

(22) Filed: Mar. 1, 2024

Related U.S. Application Data
(60) Provisional application No. 63/449,773, filed on Mar. 3, 2023.

(51) Int. Cl. G06F 9/48; G06F 9/54

(52) U.S. Cl. CPC G06F 9/4881; G06F 9/547

(57) ABSTRACT

Systems, devices, media, and methods are presented that provide an asynchronous task scheduling framework in which tasks are asynchronously scheduled for performance by a server system. Scheduling of a task is performed by marshalling the task (units of work converted to bytes) and storing the task in queues and retrieving the task from the queues and unmarshalling the retrieved tasks (bytes to units of work). The unmarshalled task is sent to a service (e.g., an email service) for performance. Examples of the approach introduce wrapping a hypertext transfer protocol (HTTP)/remote procedure call (RPC) call and brokering it transparently through a high-throughput message queue system.

### CROSS-REFERENCE TO RELATED APPLICATIONS

This application claims priority to U.S. Provisional Application Ser. No. 63/449,773 filed on Mar. 3, 2023, the contents of which are incorporated fully herein by reference.

### TECHNICAL FIELD

Examples set forth in this disclosure relate generally to applications running on server systems. More particularly, but not by way of limitation, this disclosure addresses systems and methods for optimizing the scheduling of tasks.

### BACKGROUND

A task framework is a structured approach to breaking down a complex task into smaller, more manageable sub-tasks. In computer programming, a task typically refers to a discrete unit of work that a program is designed to execute.

### BRIEF DESCRIPTION OF THE DRAWINGS

The disclosed subject matter is best understood from the following detailed description when read in connection with the accompanying drawings, with like elements having the same reference numerals. When a plurality of similar elements is present, a single reference numeral may be assigned to the plurality of similar elements with a small letter designation referring to specific elements. When referring to the elements collectively or to a non-specific one or more of the elements, the small letter designation may be dropped.

To easily identify the discussion of any particular element or act, the most significant digit or digits in a reference number refer to the figure number in which that element is first introduced. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a block diagram of an example task performance system in an online client-server system.

FIG. 2 is a block diagram illustrating an example task performance system.

FIG. 3 is a flow diagram illustrating example communications between components of the task performance system of FIG. 2.

FIG. 4 is a block diagram of an example hardware configuration for a client device embodied as a mobile device.

FIG. 5 is a block diagram of a machine in the form of a computer system within which a set of instructions may be executed for causing the machine to perform any one or more of the methodologies described herein, in accordance with some examples.

FIG. 6 is a block diagram of a software architecture within which aspects of the present disclosure may be implemented, in accordance with some examples.

### DETAILED DESCRIPTION

An asynchronous task scheduling framework in which tasks are asynchronously scheduled for performance by a server system. Scheduling of a task is performed by marshalling the task (units of work converted to bytes) and storing the task in queues and retrieving the task from the queues and unmarshalling the retrieved tasks (bytes to units of work). The unmarshalled task is sent to a service (e.g., an email service) for performance.

Traditional application protocols operate in a synchronous request/response flow of information, with the exception of some remote procedure call (RPC) configurations (e.g., Google® RPC (gRPC) configurations). Examples of the approach described herein introduce wrapping a hypertext transfer protocol (HTTP)/gRPC call and brokering it transparently through a high-throughput message queue system. In contrast to existing systems, establishing the serialization/deserialization of these messages is entirely at the discretion of the developer. This provides a way of leveraging the serialization of gRPC or HTTP along with other features to broker calls between a service producer (e.g., a user or sender of tasks) and a service consumer (e.g., a service performed such as an email service).

Conventionally, if a developer wanted to enqueue a task and then later process it in either the same service or a different distributed system they had to perform the following: establish authentication; in the case of a different service consuming the message, share the keys in some auth contract to access the tasks; create a message contract for serialization/deserialization; and maintain relayers to pull the messages and broker them to downstream consumers. Examples described herein provide a platform that leverages an internal authorization (auth) graph to remove the need to manage authentication between the task source and sink. To remove the need to establish a specific message contract, in one example, a task scheduling service is implemented underneath gRPC/HTTP, with the entire call serialized in an opaque manner. This removes the need for the developer to establish and communicate their contract. Additionally, the users of such a platform do not need to manage relayers to interact with their queues as examples of the platform rely on providing an entirely push queue implementation that can be maintained and scaled horizontally.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

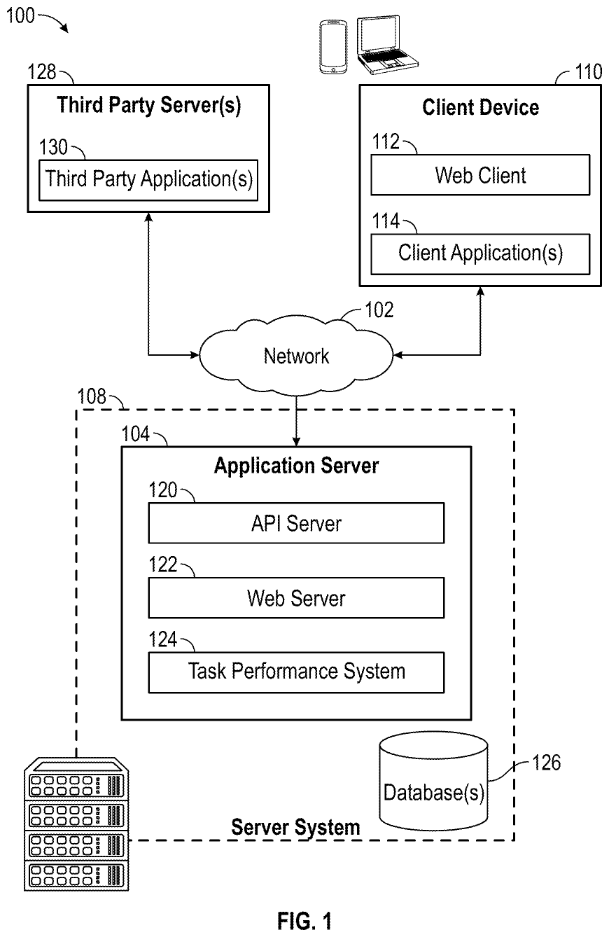

FIG. 1 is a block diagram illustrating a system 100, according to some examples, configured to schedule and perform tasks. The system 100 includes one or more client devices such as client device 110. The client device 110 includes, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the system 100. In some examples, the client device 110 includes a display module (not shown) to display information (e.g., in the form of user interfaces). In further examples, the client device 110 includes one or more of touch screens, accelerometers, gyroscopes, cameras, microphones, global positioning system (GPS) devices, and so forth. The client device 110 may be a device of a user that is used to access and utilize an online social platform. For example, the client device 110 may be used to input information to create an account, exchange information over a network 102.

For example, client device 110 may be a device of a user who is using a social media application on the device. Client device 110 may call a server for a social platform (e.g., hosted by server system 108) via the social media application directly or through one or more third-party servers 128 (e.g., utilizing one or more third-party applications 130). Application server 104 schedules and performs tasks.

One or more users may be a person, a machine, or other means of interacting with the client device 110. In examples, the user may not be part of the system 100 but may interact with the system 100 via the client device 110 or other means. For instance, the user may provide input (e.g., touch screen input or alphanumeric input) to the client device 110 and the input may be communicated to other entities in the system 100 (e.g., third-party servers 128, server system 108, etc.) via the network 102. In this instance, the other entities in the system 100, in response to receiving the input from the user, may communicate information to the client device 110 via the network 102 to be presented to the user. In this way, the user interacts with the various entities in the system 100 using the client device 110.

The system 100 further includes a network 102. One or more portions of network 102 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, another type of network, or a combination of two or more such networks.

The client device 110 may access the various data and applications provided by other entities in the system 100 via web client 112 (e.g., a browser) and/or one or more client applications 114. The client device 110 may include one or more client application(s) 114 (also referred to as “apps”) such as, but not limited to, a web browser, messaging application, electronic mail (email) application, an e-commerce site application, a mapping or location application, and the like.

In some examples, one or more client application(s) 114 are included in a given one of the client device 110, and configured to locally provide the user interface and at least some of the functionalities, with the client application(s) 114 configured to communicate with other entities in the system 100 (e.g., third-party server(s) 128, server system 108, etc.), on an as-needed basis, for data processing capabilities not locally available (e.g., to access location information, to authenticate a user, etc.). Conversely, one or more client application(s) 114 may not be included in the client device 110, and then the client device 110 may use its web browser to access the one or more applications hosted on other entities in the system 100 (e.g., third-party server(s) 128, server system 108, etc.).

A server system 108 provides server-side functionality via the network 102 (e.g., the Internet or wide area network (WAN)) to: one or more third party server(s) 128, and one or more client devices 110. The server system 108 includes an application program interface (API) server 120, a web server 122, and a task performance system 124, that may be communicatively coupled with one or more database(s) 126. The one or more database(s) 126 may be storage devices that store data (e.g., in a dataset) related to users of the server system 108, applications associated with the server system 108, cloud services, and so forth. The one or more database(s) 126 may further store information related to third party server(s) 128, third-party application(s) 130, client device 110, client application(s) 114, users, and so forth. In one example, the one or more database(s) 126 may be cloud-based storage.

In one example the server system 108 includes a task performance system 124. Task performance system 124 may include one or more servers and may be associated with a cloud-based application. Task performance system 124 may receive tasks, marshall the received task, unmarshall the received tasks, and perform services for carrying out the tasks.

The system 100 further includes one or more third party server(s) 128. The one or more third-party server(s) 128 may include one or more third-party application(s) 130. The one or more third-party application(s) 130, executing on third party server(s) 128 may interact with the server system 108 via API server 120 via a programmatic interface provided by the API server 120. For example, one or more of the third-party applications 132 may request and utilize information from the server system 108 via the API server 120 to support one or more features or functions on a website hosted by the third party or an application hosted by the third party. The third-party application(s) 130, for example, may provide software version analysis functionality that is supported by relevant functionality and data in the server system 108.

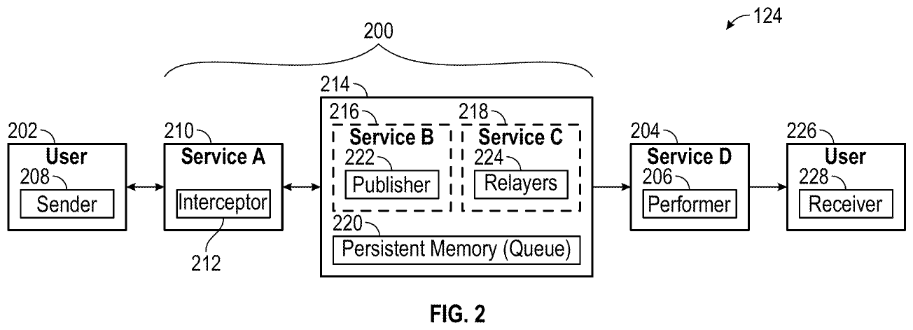

FIG. 2 is a block diagram illustrating an example of the task performance system 124. The task performance system 124 includes a collection of services (represented by service A 210, service B 216, service C 218, and service D 204) for carrying out a task initiated by a sender 208. In one example, the task is an email distribution from a user 202 to a plurality of other users (including user 226) carried out by a performer 206 (such as an email distribution service performer). Although an email distribution is described herein, the task performance system 124 can be applied to essentially any computer task that can be broken down into subtasks including, by way of non-limiting example, database sweeps, scheduling, cleanups, data change application program interface (API) operations, alerts to customers of user data changes, multi-casting to invalidate caches, push notifications (e.g., phone reputation, spam and abuse; email reputation), and short message/messaging service (SMS).

As used herein, the term “user” is used to refer to an initiator of a service or a beneficiary or recipient of a service. The user may be a human or another computer service. Additionally, the initiator user and the beneficiary/recipient user may be the same. As used herein, the term “service” service refers to a program or application that provides specific functionality or capabilities to other computer programs, users, or services. The services may run in the background without any human user interaction.

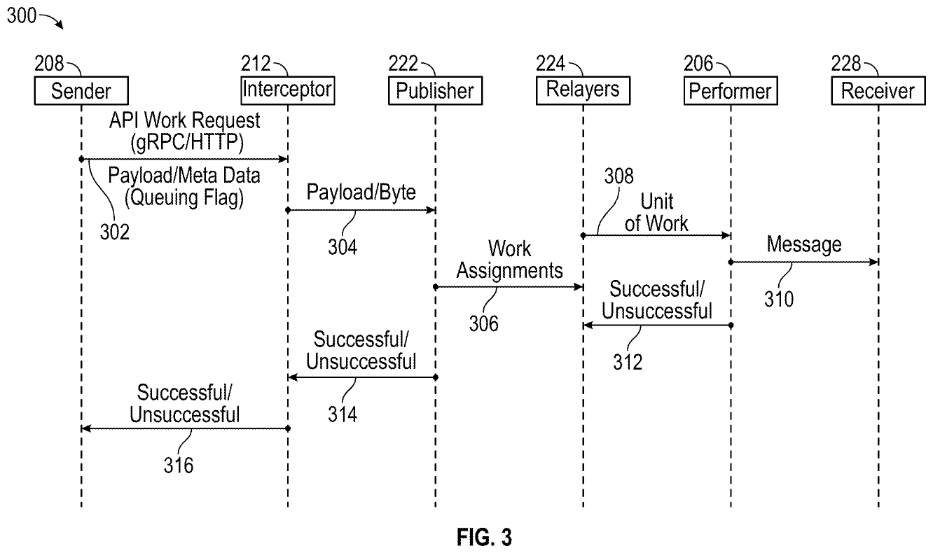

An illustrative example is now provided for an email distribution with reference to the task performance system of FIG. 2 and the corresponding communication flow diagram of FIG. 3.

A sender 208 initiates the task processing by sending a work request communication 302 (via an API interface) to Service A 210. In an example, the work request communication 302 is a gRPC implemented using HTTP and includes a payload (i.e., data) and metadata (e.g., data providing context for the payload) defining the work. The meta data includes a flag (referred to herein as a queueing flag) designating the work for queueing using the task scheduler 200. In an email distribution example, the work may be sending the message “Hello” to all i-phones.

The task scheduler 200 receives the work request communication 302 defining the work from the sender 208 (via the API interface). The task scheduler 200, in the illustrated example, is implemented using Service A 210 and a scheduling service 214 comprised of Service B 216 and Service C 218, which share a persistent memory 220 for queueing task related data. It is to be understood that the functionality of Service B 216 and Service C 218 can be merged into a single service or divided into three or more services.

Service A 210 includes an interceptor 212 configured to receive and process the work request communication 302. When the interceptor 212 identifies the queueing flag, the interceptor 212 notifies the Service A 210 to route the work request to the scheduling service 214. Additionally, the interceptor 212 marshalls the work request by breaking the work request down into units of work (referred to herein as tasks) and coverts the units of work to bytes representing the units of work.

In response to identification of the queueing flag, Service A 210 sends a communication 304 to Service B 216. The communication 304 includes the bytes representing the units of work (which includes the payload).

Service B 216 includes a publisher 222 configured to queue the bytes within persistent memory 220, gather information as needed to perform the units of work represented by the bytes (e.g., gather email addresses of all desired or defined recipients), and assigns the units of work to relayers 224 of Service C 218 via communication 306.

The relayers 224 of Service C 218, in response to receiving the assigned units of work, process the task. The relayers 224 are configured to unmarshall tasks from the queues in persistent memory 220 by converting the queued bytes back to units of work and to perform the task by sending the task to a Service D 204 via a unit of work communication 308.

The Service D includes a service performer 206 for carrying out the task to provide a service to a user 226. The service performer 206 may be a conventional service such as an email service performer 206 for delivering emails to designated recipients. In an email service example, the email service performer 206 may send an email message 310 to a receiver 228.

In an example, upon completion of a task, notifications are sent between the Services A-D and ultimately to the sender 208 informing the sender 208 that the work request was completed. For example, after receipt of a unit of work/task from the relayer 224 in communication 308, the performer 206 sends a communication 312 indicating to the task scheduler 200 whether the task was successfully completed. The task scheduler 200, in turn, sends a communication 314 to the interceptor 212 indicating to the interceptor 212 whether the task was successfully completed. The interceptor 212 monitors the communications 314 and, once communications 314 for all tasks of a work request are received, notifies the sender 208 whether the work request was successful via communication 316.

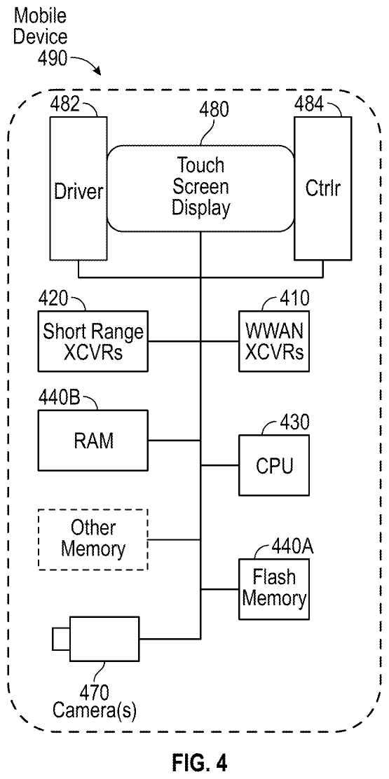

FIG. 4 is a high-level functional block diagram of an example client device 110 embodied as an example mobile device 490. Mobile device 490 includes a flash memory 440A that includes programming to perform all or a subset of the functions described herein. Mobile device 490 can include a camera 470 that comprises at least two visible light cameras (first and second visible light cameras with overlapping fields of view) or at least on visible light camera and a depth sensor with substantially overlapping fields of view. Memory 440A may further include multiple images or video, which are generated via the camera 470.

As shown, the mobile device 490 includes an image display 480, an image display driver 482 to control the image display 480, and a controller 484. In the example of FIG. 4, the image display 480 and a user input device are integrated together into a touch screen display.

Examples of touch screen type mobile devices that may be used include (but are not limited to) a smart phone, a personal digital assistant (PDA), a tablet computer, a laptop computer, or other portable device. However, the structure and operation of the touch screen type devices is provided by way of example; and the subject technology as described herein is not intended to be limited thereto. For purposes of this discussion, FIG. 4 therefore provides block diagram illustrations of the example mobile device 490 having a touch screen display for displaying content and receiving user input as (or as part of) the user interface.

As shown in FIG. 4, the mobile device 490 includes at least one digital transceiver (XCVR) 410, shown as WWAN XCVRs, for digital wireless communications via a wide area wireless mobile communication network. The mobile device 490 also includes additional digital or analog transceivers, such as short range XCVRs 420 for short-range network communication, such as via NFC, VLC, DECT, ZigBee, Bluetooth™, or WiFi. For example, short range XCVRs 420 may take the form of any available two-way wireless local area network (WLAN) transceiver of a type that is compatible with one or more standard protocols of communication implemented in wireless local area networks, such as one of the Wi-Fi standards under IEEE 802.11.

To generate location coordinates for positioning of the mobile device 490, the mobile device 490 can include a global positioning system (GPS) receiver. Alternatively, or additionally the mobile device 490 can utilize either or both the short range XCVRs 420 and WWAN XCVRs 410 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 410, 420.

The transceivers 410, 420 (network communication interface) conform to one or more of the various digital wireless communication standards utilized by modern mobile networks. Examples of WWAN transceivers 410 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” For example, the transceivers 410, 420 provide two-way wireless communication of information including digitized audio signals, still image and video signals, web page information for display as well as web related inputs, and various types of mobile message communications to/from the mobile device 490.

The mobile device 490 further includes a microprocessor, shown as CPU 430, sometimes referred to herein as the host controller. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 430, for example, may be based on any known or available microprocessor architecture, such as a Reduced Instruction Set Computing (RISC) using an ARM architecture, as commonly used today in mobile devices and other portable electronic devices. Of course, other processor circuitry may be used to form the CPU 430 or processor hardware in smartphone, laptop computer, and tablet.

The microprocessor 430 serves as a programmable host controller for the mobile device 490 by configuring the mobile device 490 to perform various operations, for example, in accordance with instructions or programming executable by processor 430. For example, such operations may include various general operations of the mobile device, as well as operations related to the programming for the task scheduler 200. Although a processor may be configured by use of hardwired logic, typical processors in mobile devices are general processing circuits configured by execution of programming.

The mobile device 490 includes a memory or storage device system, for storing data and programming. In the example, the memory system may include a flash memory 440A and a random access memory (RAM) 440B. The RAM 440B serves as short term storage for instructions and data being handled by the processor 430, e.g., as a working data processing memory. The flash memory 440A typically provides longer term storage.

Hence, in the example of mobile device 490, the flash memory 440A is used to store programming or instructions for execution by the processor 430. Depending on the type of device, the mobile device 490 stores and runs a mobile operating system through which specific applications, including programming for the task scheduler 200 are executed. Applications, such as task applications and programming for the task scheduler 200, may be a native application, a hybrid application, or a web application (e.g., a dynamic web page executed by a web browser) that runs on mobile device 490. Examples of mobile operating systems include Google Android, Apple iOS (I-Phone or iPad devices), Windows Mobile, Amazon Fire OS, RIM BlackBerry operating system, or the like.

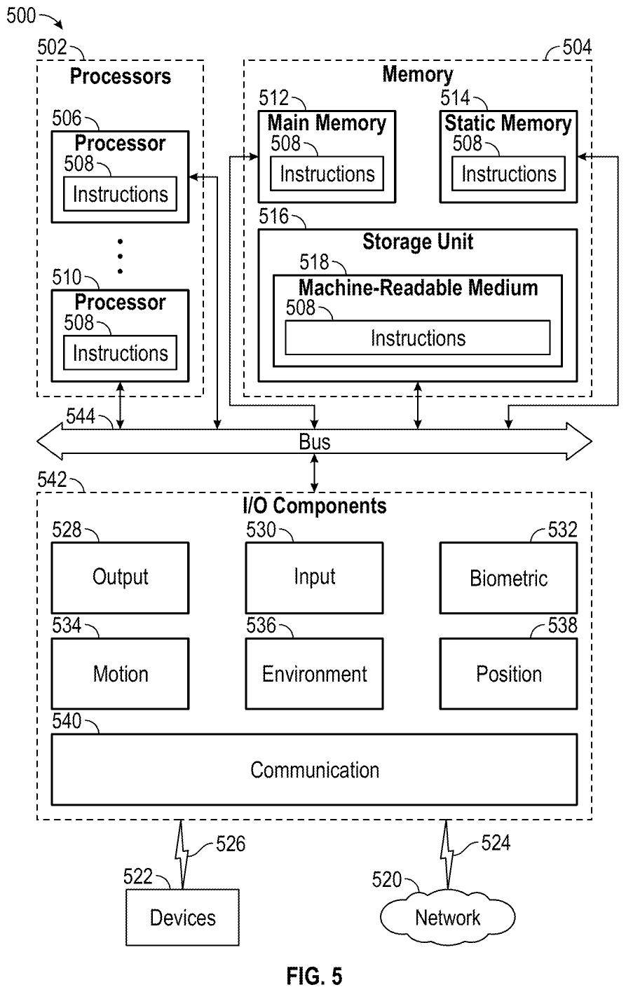

FIG. 5 is a diagrammatic representation of a machine 500 within which instructions 508 (e.g., software, a program, an application, an applet, an app, or other executable code) for causing the machine 500 to perform any one or more of the methodologies discussed herein may be executed. For example, the instructions 508 may cause the machine 500 to execute any one or more of the methods described herein. The instructions 508 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment.

The machine 500 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 508, sequentially or otherwise, that specify actions to be taken by the machine 500. Further, while only a single machine 500 is illustrated, the term “machine” shall also be taken to include a collection of machines that individually or jointly execute the instructions 508 to perform any one or more of the methodologies discussed herein.

The machine 500 may include processors 502, memory 504, and I/O components 542, which may be configured to communicate with each other via a bus 544. In an example, the processors 502 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 506 and a processor 510 that execute the instructions 508. The term “processor” is intended to include multi-core processors that may comprise two or more independent processors (sometimes referred to as “cores”) that may execute instructions contemporaneously. Although FIG. 5 shows multiple processors 502, the machine 500 may include a single processor with a single core, a single processor with multiple cores (e.g., a multi-core processor), multiple processors with a single core, multiple processors with multiples cores, or any combination thereof.

The memory 504 includes a main memory 512, a static memory 514, and a storage unit 516, both accessible to the processors 502 via the bus 544. The main memory 504, the static memory 514, and storage unit 516 store the instructions 508 embodying any one or more of the methodologies or functions described herein. The instructions 508 may also reside, completely or partially, within the main memory 512, within the static memory 514, within machine-readable medium 518 (e.g., a non-transitory machine-readable storage medium) within the storage unit 516, within at least one of the processors 502 (e.g., within the processor's cache memory), or any suitable combination thereof, during execution thereof by the machine 500.

Furthermore, the machine-readable medium 518 is non-transitory (in other words, not having any transitory signals) in that it does not embody a propagating signal. However, labeling the machine-readable medium 518 “non-transitory” should not be construed to mean that the medium is incapable of movement; the medium should be considered as being transportable from one physical location to another. Additionally, since the machine-readable medium 518 is tangible, the medium may be a machine-readable device.

The I/O components 542 may include a wide variety of components to receive input, provide output, produce output, transmit information, exchange information, capture measurements, and so on. The specific I/O components 542 that are included in a particular machine will depend on the type of machine. For example, portable machines such as mobile phones may include a touch input device or other such input mechanisms, while a headless server machine will likely not include such a touch input device. It will be appreciated that the I/O components 542 may include many other components that are not shown in FIG. 5. In various examples, the I/O components 542 may include output components 528 and input components 530. The output components 528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 530 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 542 may include biometric components 532, motion components 534, environmental components 536, or position components 538, among a wide array of other components. For example, the biometric components 532 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 534 include acceleration sensor components (e.g., accelerometer), gravitation sensor components, rotation sensor components (e.g., gyroscope), and so forth. The environmental components 536 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 538 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 542 further include communication components 540 operable to couple the machine 500 to a network 520 or devices 522 via a coupling 524 and a coupling 526, respectively. For example, the communication components 540 may include a network interface component or another suitable device to interface with the network 520. In further examples, the communication components 540 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 522 may be another machine or any of a wide variety of peripheral devices (e.g., a peripheral device coupled via a USB).

Moreover, the communication components 540 may detect identifiers or include components operable to detect identifiers. For example, the communication components 540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 540, such as location via Internet Protocol (IP) geolocation, location via Wi-Fi® signal triangulation, location via detecting an NFC beacon signal that may indicate a particular location, and so forth.

The various memories (e.g., memory 504, main memory 512, static memory 514, memory of the processors 502), storage unit 516 may store one or more sets of instructions and data structures (e.g., software) embodying or used by any one or more of the methodologies or functions described herein. These instructions (e.g., the instructions 508), when executed by processors 502, cause various operations to implement the disclosed examples.

The instructions 508 may be transmitted or received over the network 520, using a transmission medium, via a network interface device (e.g., a network interface component included in the communication components 540) and using any one of a number of well-known transfer protocols (e.g., hypertext transfer protocol (HTTP)). Similarly, the instructions 508 may be transmitted or received using a transmission medium via the coupling 526 (e.g., a peer-to-peer coupling) to the devices 522.

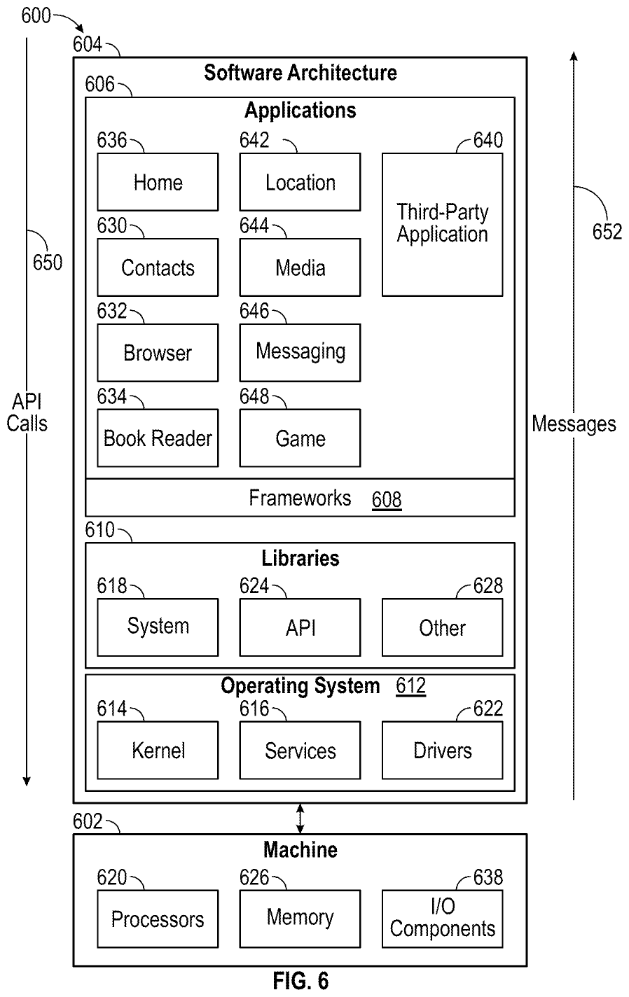

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionality. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 610 provide a low-level common infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a high-level common infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A method for scheduling tasks, the method comprising:
receiving a work request;
generating tasks for carrying out the work request;
marshalling the tasks;
storing the marshalled tasks in queues;
retrieving the task from the queues;
unmarshalling the retrieved tasks;
sending the unmarshalled tasks to at least one service performer for execution.

2. The method of claim 1, wherein the work request is a remote procedure call.

3. The method of claim 2, wherein the remote procedure call includes a flag and wherein the method further comprises:
identifying the flag in the remote procedure call;
wherein the tasks are generated in response to identification of the flag.

4. The method of claim 1, wherein the marshalling comprises:
converting the tasks to bytes;
wherein the storing comprises storing the bytes in persistent memory.

5. The method of claim 4, wherein the retrieving comprises:
retrieving the bytes from persistent memory;
wherein the unmarshalling comprises converting the retrieved bytes to the tasks.

6. The method of claim 1, further comprising:
gathering data for performing the marshalled tasks.

7. The method of claim 6, further comprising:
assigning the marshalled tasks and providing the gathered data to relayers configured to unmarshall the tasks.

8. A system for scheduling tasks, the system comprising:
an interceptor configured to receive a work request, generate tasks for carrying out the work request, and marshall the tasks;
a publisher configured to store the marshalled tasks in queues; and
relayers configured to retrieve the task from the queues, unmarshall the retrieved tasks, and send the unmarshalled tasks to at least one service performer for execution.

9. The system of claim 8, wherein the work request is a remote procedure call including a flag and wherein the interceptor is further configured to:
identify the flag in the remote procedure call; and
generate the tasks in response to identification of the flag.

10. The system of claim 8, wherein the interceptor is further configured to:
convert the tasks to bytes; and
send the bytes to the publisher.

11. The system of claim 10, wherein the publisher is further configured to:
store the bytes in persistent memory.

12. The system of claim 11, wherein the relayers are further configured to:
retrieve the bytes from persistent memory; and
convert the retrieved bytes to the tasks.

13. The system of claim 8, wherein the publisher is further configured to:
gather data for performing the marshalled tasks.

14. The system of claim 13, wherein the publisher is further configured to:
assign the marshalled tasks and provide the gathered data to the relayers;
wherein the relayers are further configured to unmarshall the tasks.

15. A non-transitory computer-readable storage medium storing instructions that, when executed by a server system, cause the server system to:
receive a work request;
generate tasks for carrying out the work request;
marshall the tasks;
store the marshalled tasks in queues;
retrieve the task from the queues;
unmarshall the retrieved tasks; and
send the unmarshalled tasks to at least one service performer for execution.

16. The non-transitory computer-readable storage medium of claim 15, wherein the work request is a remote procedure call.

17. The non-transitory computer-readable storage medium of claim 16, wherein the instructions further cause the server system to:
identify a flag in the remote procedure call;
wherein to generate the tasks the instructions further cause the server system to generate the tasks in response to identification of the flag.

18. The non-transitory computer-readable storage medium of claim 15, wherein to marshall the tasks the instructions further cause the server system to:
convert the tasks to bytes;
wherein to store the marshalled tasks in the queues the instructions further cause the server system to store the bytes in persistent memory.

19. The non-transitory computer-readable storage medium of claim 18, wherein to retrieve the task from the queues the instructions further cause the server system to:
retrieve the bytes from persistent memory;
wherein to unmarshall the retrieved tasks the instructions further cause the server system to convert the retrieved bytes to the tasks.

20. The non-transitory computer-readable storage medium of claim 15, wherein the instructions further cause the server system to:
gather data for performing the marshalled tasks; and
assigning the marshalled tasks and providing the gathered data to relayers configured to unmarshall the tasks.
